(19) United States
(12) Patent Application Publication
(10) Pub. No.: US 2018/0202902 A1
(43) Pub. Date: Jul. 19, 2018

(54) METHOD FOR SAMPLING AND EXTRACTING POLLUTANTS IN A FLUID, SAMPLING CARTRIDGE, SAMPLING AND EXTRACTING DEVICES USING SAID METHOD

(71) Applicants: ACTION EUROPE SARL, Sausheim (FR); NCX SARL, Garlin (FR)

(72) Inventors: Olivier HOFFARTH, Sausheim (FR); Serge JUNCA, Maspie Lalonquere Juillacq (FR)

(73) Assignees: ACTION EUROPE SARL, Sausheim (FR); NCX SARL, Garlin (FR)

(21) Appl. No.: 15/574,572

(22) PCT Filed: May 17, 2016
(86) PCT No.: PCT/EP2016/060999

§ 371 Date: Nov. 16, 2017

(30) Foreign Application Priority Data
May 22, 2015 (FR) 15/54663

(51) Int. Cl. G01N 1/22; G01N 1/10

(52) U.S. Cl. CPC G01N 1/2273; G01N 1/10; G01N 1/2214; G01N 30/06; G01N 2001/2276; G01N 2001/2285; G01N 2001/2223

(57) ABSTRACT

A sampling cartridge (1), a sampling device (2, 3), an extracting device (4) and a sampling and extracting device (5) which allow safe measurement without contamination of the adsorbent, before or after sampling. The sampling cartridge (1) comprises an envelope (10) made from an inert material in which an adsorbent material (13) is sealed, in a leaktight manner, by two caps (11, 12) located at the two ends (100, 101) of the envelope. Each cap (11, 12) has an opening (111, 121) which is closed by a seal (110, 120) formed of a silicone film and a barrier layer made of aluminum which withstands the high temperatures necessary for the thermal desorption technique. The cartridge (1) is conditioned under inert gas and its ends (100, 101) comprise at least one seal-on end piece (102) for a cap, and one universal end piece (105) for a sealed, screwed or clip-fastened cap.

### TECHNICAL SCOPE

The present invention relates to pollutants sampling in a fluid such as air or water, carried out in compliance with specific standards described in the literature.

The quality measurement of indoor ambient air generally applies to the monitoring of:
housing
premises open to the public
offices

The quality measurement of running water relates to the water distributed in housings and in all public places, but also to the surface water of rivers, well water, etc.

These application examples are of course not limiting.

The present invention thus relates to a method for sampling and extracting pollutants in a fluid, a sampling cartridge, various sampling and extracting devices using said method.

### STATE OF THE ART

Sampling of pollutants in the air is performed today actively or passively. Pollutants mean for example the volatile organic compounds (VOCs), which are organic compounds that can easily be found in gaseous form in the atmosphere, but also any other type of substances harmful to health such as pesticides, herbicides, acaricides, polycyclic aromatic hydrocarbons (PAHs), etc.

In the case of passive sampling the sample is collected by means of a sampling badge. The sampling badge is worn by a person or placed in a room to be sampled and contains capsules provided with an adsorbent to perform a passive pollutant collection by diffusion through a membrane. Sampling can last from 8 hours to 4.5 days according to the exposure of the persons and to the type of pollutants to be sampled.

In the case of active sampling, the sample is collected by means of pumps connected to sampling tubes containing one or several selective adsorbents according to the type of pollutants to be collected. These adsorbents are traditionally in the form of a powder. After pumping a known quantity of air or water through the tube that contains the adsorbent used to trap the pollutants, the trapped pollutant is either extracted using a very toxic solvent of the CS2 (carbon disulfide) type or thermally desorbed with a thermal desorber.

The active sampling is generally carried out by means of a constant flow pump connected to a two-segment tube provided with one or several specific adsorbents of the activated carbon, Tenax™, chromosorb, etc. types to trap the pollutants according to their nature and of the expected concentrations.

The sampler connects the tube (trap) to the pump and sets the flow recommended according to the pollutant and to the exposure concentration tolerated by the legislator. The recommended sampling time is 24 hours (French experimental standard XPX43-402). Of course, the volume to be sampled and the flow to be respected are defined for every country in the regulations in force.

After the sampling phase, the tube is opened at one end to remove the adsorbent on which the pollutants have been collected. The two segments are subjected to an extraction with a CS2-type solvent or with benzyl alcohol before they are analyzed separately to check whether the adsorbent has not been saturated on the first segment.

These systems have many drawbacks:
Information is lost during the extraction by means of the solvent, due to the dilution of the sample, reproducibility is difficult because of the sampling mode: air current, air flow control, adsorbent homogeneousness, etc.
Sample preservation and integrity are not guaranteed, as there is a risk of contamination of the adsorbent to be analyzed since the adsorbent is put into contact with the exterior environment between the collection and the analysis.
Some compounds remain adsorbed on the adsorbent.
The extraction requires the use of polluting solvents.
The time required for the extraction is very long.
The price remains high.

The thermal desorption extraction technique is more efficient and sensitive. It is generally used within the framework of the active sampling by pumping on stainless steel or glass cartridges containing an adsorbent held in place by quartz wool. A double sampling or the division of the gas flow during desorption and the recollection of 50% in a retention tube is generally necessary to keep a reference sample. This technique requires systematic conditioning and control of the tubes prior to their use. The preservation after sampling requires using tube sealing caps whose tightness often is questionable. The tubes show large dispersion with respect to the pressure drop of every tube before and during sampling. The tubes cannot be used for sampling liquids. The internal dead volume is very important and reduces the sensitivity.

On the other hand, for passive sampling badges as well as for active sampling tubes, it is always necessary to open the ends to perform the sampling and then to re-close them to transfer the sampling badge or tube to the laboratory and carry out a gas chromatography or mass spectrometry analysis.

This multiple handling to open and close the sampling badges or tubes by means of plastic capsules or caps, caps equipped with an o-ring or closing systems with a mechanical sealing cone do not allow ensuring a perfect tightness of these sampling devices from the measuring site up to the laboratory.

Cross-contaminations between the sampling devices and the associated systems are recurrent and well known by the persons skilled in the art. Since these sampling systems are reusable, the operator must consequently condition them for hours, prior to the sampling and after the analysis, under an inert gas flow and continuous heating in order to purify them. Then, the operator must carry out a blank test of a batch of sampling devices to define their degree of purity before he carries out the actual on-site sampling.

On the other hand, the use of classic adsorbents such as Tenax® or activated carbon in real conditions shows that, according to the degree of humidity on the sampling sites, the adsorbent soaks up water, compacts and closes up to be eventually saturated with water and let the molecules searched for pass through. Moreover, the sampling tubes are generally entirely filled with adsorbents, which considerably reduces their internal volume and makes impossible a homogeneous interaction between the air or gas flow and the adsorbent to ensure proper sampling. As the tubes are always open during the sampling phase, the air flow necessarily escapes at one of its ends, further reducing the chances to achieve a representative sampling.

Publications EP 0 042 683 A1 and U.S. Pat. No. 5,574,230 illustrate two examples of this type of sampling tubes closed at their ends by removable caps rendered tight by o-rings or the like, which must be opened during the sampling phase, then closed, and opened again during the analysis phase.

Publication U.S. Pat. No. 6,167,767 B1 describes another sampling tube type whose ends are closed by a pierceable cover held by a cap crimped around an o-ring, each cap being provided with a central opening to receive a sampling needle of an automated sequential gas sampling machine. Even if, in this example, the tightness of the sampling tube is preserved before and after sampling, it is reduced to zero when analyzing the sample on a thermal desorption machine which requires removing the crimped caps.

Publication DE 10 2006 025 932 B3 describes a laboratory analysis device using a metal vial wherein a steel or glass tube containing a sample or an adsorbent to be analyzed is introduced. The end of the vial and of the tube is closed by a tight and pierceable cover, held by a screw cap, provided with a central opening crossed by two needles of an automatic thermal desorber to allow the circulation of a carrier gas around and through the tube. This device is not intended for carrying out on-site samplings and requires the handling of the sample tube before and after the analysis, with high risks of operator contamination.

Publication JP 2009 053121 A also describes a laboratory analysis device for solid samples put in a crucible placed in a high-temperature oven. The generated gases are trapped in highly heat-resistant glass tubes provided with an adsorbent to retain the gases and closed at the ends by simple highly heat-resistant flexible plugs that can be pierced by the needles of an automatic thermal desorber allowing the circulation of a carrier gas through the tube. This tube is therefore not intended for carrying out on-site sampling and its tightness is not guaranteed.

### DESCRIPTION OF THE INVENTION

The purpose of the invention is to offer a totally secure, reliable and reproducible sampling and extracting method thanks to the use of a ready-to-use single-use sampling cartridge that can be used on its own or in a dedicated sampling device, and that can feed a known or a dedicated extracting device, thus allowing a safe measurement without contamination of the adsorbent neither before nor after the sampling, as the cartridge allows carrying out all process steps from the sampling up to the analysis, and it can easily be stored and transported without loss of information. In particular, the sampling cartridge can be inert, traced and recyclable, allowing performing either active or passive samplings.

To this purpose, the method for sampling and extracting pollutants in a fluid is characterized in that one uses one and the same sampling cartridge to perform in a first step said sampling in passive mode or in active mode, and in a second step the extraction of the collected pollutants by thermal desorption and circulation of a carrier gas through said cartridge, the sampling step being carried out by means of the sole sampling cartridge or of a sampling device containing said cartridge, and the extraction step being carried out by means of an extracting device or of a sampling and extracting device containing said cartridge, said cartridge being conditioned under inert gas and comprising an envelope out of an inert material, containing an adsorbent material, sealed in a leaktight manner by two caps located at both ends of the envelope, each cap having an opening closed by a pierceable seal made of a silicone film and at least one barrier layer.

Advantageously, to perform the sampling step in passive mode, one removes one of the caps from said cartridge to open the envelope and let the fluid to be analyzed enter and, once the sampling is made, on closes the envelope again with said cap.

Advantageously, to perform the sampling step in active mode or the extraction step, one leads the fluid to be analyzed or the carrier gas through the cartridge by means of cannulas of the sampling device, of the extracting device or of the sampling and extracting device, to pierce the ends of said cartridge through said seals.

Also to this purpose, the sampling cartridge according to the invention comprises an envelope, for example a cylindrical envelope, out of an inert material, in which an adsorbent material is placed, sealed in a leaktight manner by two caps located at both ends of the envelope, each cap having an opening closed by a seal made of a silicone film and at least one barrier layer out of aluminum or Teflon™ (polytetrafluoroethylene PTFE), said cartridge being filled with a pressurized inert gas. The use of a specific film out of silicone and aluminum or out of aluminum/silicone/aluminum allows withstanding the high temperatures necessary for the thermal desorption technique, namely between 250° C. and 350° C. The silicone has a re-sealing ability that allows closing a hole that would be made in it. Aluminum has a barrier effect that allows achieving perfect tightness against the most volatile molecules. Teflon™ can replace aluminum for a similar result. The adsorbent material is thus totally isolated from the exterior environment thanks to a controlled and efficient tightness. The film also allows limiting the uncontrolled introduction of air at the completion of an active sampling. On the other hand, aluminum or Teflon™ is neutral towards the traces to be analyzed. The cartridge is preferably conditioned under inert gas (for example argon, which is heavier than air) in order to prevent any cross-contamination with the exterior environment. To date, no adsorption tube for the environmental field is conditioned under inert gas.

Offering the sampling system in the form of a cartridge allows adding a solvent such as dichloromethane to perform an extraction, preferably by shaking the cartridge. The extract will not come into contact with the air of the laboratory and cross-contamination will be impossible, unlike the systems currently on the market. After the extraction phase, injection can take place on a LC-MS system (liquid chromatography coupled with mass spectrometry), for example to dose the medicines or endocrine disruptors in the water. The solvent extraction technique directly in the cartridge can also be suitable for other applications such as dosing of allergens, narcotics, drugs or explosives. The geometry of the cartridge can be adapted to allow transferring it directly on the sample racks of the various automatic analyzers.

Advantageously, the envelope of the cartridge is preferably made of glass. The glass is amber or transparent. The use of amber glass avoids the degradation of photosensitive molecules collected. One will use preferably a type 1 borosilicate amber glass. The superficial treatment of the glass (passivation or deactivation) also allows lowering the detection limits of certain molecules such as those of the pesticides. The glass walls of the envelope can be coated with a film (deposit of a selective phase of the silicone or PDMS (polydimethylsiloxane) type) with a suitable selectivity and film thickness. After the phase deposit, the cartridge is sealed under inert gas.

The adsorbent material is advantageously a polymer. The cartridge contains a full polymer, hereinafter canned solid polymer to differentiate it from a powder polymer. It can also be a polymer in the form of a powder or polymer-coated glass balls, an adsorbent of the activated carbon or graphite type, a porous polymer of the Tenax™ type, a diatomite or a clay, any microporous adsorbent carrier, miniaturized sensors, paper carriers impregnated with a reagent or colorimetric indicators, agars. One shall prefer the use of a solid, hydrophobic polymer, with high adsorption capacity, such as for example a solid and inert organomineral polymer of the siloxane family. It will be single-use, ready-to-use and will form a consumable. It can have the shape of a for example cylindrical stick positioned inside the tube by means of one or two axial centering elements. The centering element is a metal grid with a known and regular porosity, for example 200 μm, provided with a central hole equal to the diameter of the polymer stick (cylinder) allowing positioning axially the polymer in the center of the cartridge and at equal distances from the walls of the glass envelope. This technique will allow a homogeneous exchange of the gaseous or liquid phase with the polymer during the adsorption phase.

Advantageously, one of the caps is crimped on the envelope of the cartridge and the other cap is crimped, clipped or screwed on the envelope. The cartridge then has a crimp-on end piece with a diameter of for example 11 mm on one side, and for example a 11 mm clip-on end piece on the other side, allowing the use of clip-on caps, but also of crimp-on caps. It can also comprise a universal end piece allowing the use of screw-on, clip-on or crimp-on caps. This configuration allows opening the cartridge without using specific tools for removing the polymer if necessary or for carrying out a passive sampling.

Advantageously, the envelope of the cartridge is made of a reusable material, for example if the tube is made of glass. One thus obtains a single-use device which is partly recyclable and therefore environmentally friendly. The glass cartridge can be recycled by the manufacturer. The product is environmentally friendly and reusable after having extracted the caps and cleaned and decontaminated the glass.

The cartridge can advantageously comprise an individual traceability marking.

It can also comprise a heating resistor integrated in its glass envelope, and the caps can be out of metal to form electrodes connected to said heating resistor, for the thermal desorption step.

For the purpose stated above, the invention also relates to a sampling device comprising a space for a sampling cartridge as defined above, characterized in that it comprises a fixed cannula and a cannula movable in translation arranged on either side of the space, a means for actuating the movable cannula between a retracted position and a cartridge piercing position, and a system for locking the movable cannula in piercing position, said cannulas being connected to a circuit for the fluid to be analyzed. The cartridge does not need to be opened, as sampling will take place via the cannulas. The use is therefore easy.

Advantageously, a cannula is mounted on a removable fitting. This allows easy dismounting and cleaning of the cannula.

The cannula has advantageously a tapered tip with at least one side bore. This prevents clogging by the cartridge seal.

The actuating means advantageously comprises a return spring. The spring allows the movable cannula to move back to a retracted position when it is released from the piercing position.

The actuating means advantageously comprises a locking system using a chicane. The cannula is locked in piercing position by the actuating means itself.

According to a particular arrangement, the device comprises a charge level indicator of a battery provided to power a fluid suction pump. This indicator will for example be a LED.

According to another arrangement, the device comprises an interruption indicator for the power supply of said pump. This will allow identifying wrong measurements. This indicator can be made of a LED.

It advantageously comprises an indicator of the selected incrementation time.

According to a first variant, one of the cannulas is open towards the external air and the other is connected to a suction pump. This variant allows measuring air pollution in a room or in a given environment.

According to a second variant, one of the cannulas is connected to a water supply and the other to a gravity discharge outlet. This variant allows for example analyzing and measuring the pollution of the tap water distributed daily to millions of homes. A specific housing to be screwed on the water tap outlet is then provided. Once it is screwed in place, it will be sufficient to switch on or arm the double-needle sampling device to let tap water flow through the cartridge and concentrate the present pollutants on the adsorbent material. It can also be equipped with a device to measure or check the water flow that passed through the sampling cartridge.

A solenoid valve is advantageously located upstream of the cannula connected to the water supply. This solenoid valve can comprise a delay time in order to define a quantity of water to be analyzed.

According to a third variant, the cannulas end in a same water vial and a pump is located between one of the cannulas and the vial. The water circulates then in a closed circuit, making it possible to work over a non-limited time.

According to a fourth variant, one of the cannulas comprises a mouthpiece. This allows analyzing the expired air. A single-use mouthpiece (of the alcoholmeter type) will be screwed on the sampling device containing the sampling cartridge. This device will allow concentrating the air expired by a person in order to concentrate possible markers or metabolites allowing identifying certain forms of cancer. The expired air passes through the sampling cartridge containing the polymer or a specific adsorbent material to be concentrated there before being evacuated through a cannula with a large inner diameter located at the outlet of the cartridge. The patient will have to repeat the blowing several times, according to various criteria. The system can be equipped with a device to measure or check the air flow that passed through the sampling cartridge. After the sampling phase, the cartridge will be analyzed by thermal desorption or extraction followed by a GC-MS or LC-MS (gaseous or liquid chromatography coupled with mass spectrometry) identification.

The invention also relates to a passive sampling device, said device comprises a hollow body defining a space for a sampling cartridge as defined above, characterized in that the hollow body comprises a tightly closed end and an open end, the device comprises two plugs mounted in a removable manner on said ends so as to be interchangeable, a first tight plug and a second open plug comprising a diffusion grid. With this device, the cartridge is introduced in the hollow body, which is specific and can be worn by an operator thanks to a clip, fastened onto a metallic background with the magnet or be suspended with a ring attached to the clip. The device can be provided with all these accessories as the sampling height is very important. Before use, the tight cap must be removed from the cartridge, then the tight plug must be exchanged with the plug equipped with the diffusion grid. During sampling, the air will pass through the diffusion grid, which can be made of stainless steel, which allows obtaining a controlled passage through a standardized opening. After sampling, the tight cap is put back in place on the cartridge and the plug with the seal is screwed on the device. This passive sampling device has the advantage of offering double tightness and double functionality. The closed end of the hollow body advantageously comprises a recess closed by one of the plugs to receive one of the caps of the cartridge during the sampling step. So the device, in addition to serving for collecting the sample, also keeps the tight cartridge cap in the plug until completion of the sampling. The seal ensures the tightness of the device when sending the whole to the laboratory. This sampling device ensures the preservation of the collected sample. The tight plug can comprise a magnet to fasten said device onto any metallic support.

The invention also relates to a passive sampling device comprising a cartridge as defined above, characterized in that the cartridge is equipped with a diffusion grid arranged close to an end of the envelope and with a tight cap clipped or screwed on said end. It is therefore possible to use the cartridge itself as a sampling device by removing the removable cap to perform the sampling and putting it back in place once the sampling is completed.

The invention also relates to an extracting device arranged between a carrier gas inlet and an analyzer, and comprising a hollow body that defines a space for a sampling cartridge as defined above, and a heating element of the cartridge, characterized in that it comprises a fixed cannula and a cannula movable in translation arranged on each side of the housing, a pusher coupled with the movable cannula to move it between a retracted position and a cartridge piercing position, one of the cannulas being intended for being connected to the carrier gas inlet and the other cannula being intended for being connected to the injector of an analyzer. The movable cannula is advantageously actuated by screwing. The cannula can therefore easily be pressed into the cartridge to be analyzed. The carrier gas is thus injected on one side by a cannula to extract the elements to be analyzed and exits on the other side through the other cannula connected to the injector of an analyzer. The carrier gas, with the elements to be analyzed, arrives this way to the analyzer without external contamination.

The invention also relates to a sampling and extracting device, characterized in that it comprises the above extracting device connected to a body comprising a suction pump and an inert gas tank, one of the cannulas being connected through a solenoid valve to said suction pump during the sampling step or to said inert gas tank during the extraction step, and the other cannula being intended to be connected to an air inlet during the sampling step or to an analyzer during the extraction step. This way, the cartridge as defined above can be put into the device which, in sampling mode, will be able to suck in for example the exterior air thanks to the pump; once sampling is completed, the cartridge will be heated and the gas contained in the cartridge will be re-injected in an analyzer.

Further advantages will appear to the persons skilled in the art when reading the examples below, illustrated by the attached figures, which are given for illustrative purposes.

### BRIEF DESCRIPTION OF THE DRAWINGS

FIG. 1 is a cross-section of a first example of a cylindrical envelope of the cartridge according to the invention,

FIG. 2 is a cross-section of a second example of a cylindrical envelope of the cartridge according to the invention,

FIG. 3 is a cross-section of a third example of a cylindrical envelope of the cartridge according to the invention,

FIG. 4 is a perspective view of a cap of the cartridge according to the invention,

FIG. 5 is a cross-section of a first embodiment of a sampling device according to the invention,

FIG. 6 is the detail of the cannula of the device of FIG. 5,

FIG. 7 is the detail of the tip of the cannula of FIG. 6,

FIG. 8 is a perspective view of the device of FIG. 5.

FIG. 9 is a cross-section of a second embodiment of a sampling device according to the invention in sampling position,

FIG. 10 is a cross-section of the second embodiment of a sampling device in transport position,

FIG. 11 is a cross-section of the extracting device according to the invention,

FIG. 12 is a cross-section of a passive sampling cartridge,

FIG. 13 is a cross-section of the sampling and extracting device according to the invention, and

FIG. 14 is a perspective view of FIG. 13.

### ILLUSTRATIONS OF THE INVENTION AND VARIOUS WAYS OF REALIZING IT

Sampling cartridge 1 according to the invention comprises a cylindrical envelope 10, 10′, 10″, two caps 11 and 12 arranged on either side or at every end 100, 101 of envelope 10, 10′, 10″ and an adsorbent material 13 placed inside of envelope 10, 10′, 10″. Envelope 10, 10′, 10″ can be made of amber or transparent glass. Amber glass has the advantage of protecting adsorbent material 13 and the adsorbed photosensitive molecules from the light. Glass in general also has the advantage of being an inert material and to have an excellent heat conductivity, thus reducing the duration of the thermal desorption. This envelope 10, 10′, 10″ of cartridge 1 is preferably cylindrical, but it can have other cross-sections, for example square, hexagonal, ovoid, etc. according to the applications. Adsorbent material 13 will be for example a single-use, ready-to-use solid polymer or specific adsorbents allowing trapping in a universal manner all types of pollutants. Caps 11 and 12 are sealed in a leaktight manner on envelope 10, 10′, 10″. They can also be screwed, clipped or crimped according to the applications. Closing must preferably withstand high temperatures, namely up to 350° C. and have specific containment properties and excellent neutrality.

If a solid polymer is used, it can be single-use and ready-to-use. One shall choose preferably a hydrophobic polymer, with high adsorbent capacity, such as for example a solid and inert organomineral polymer of the siloxane family. It can have the shape of a for example cylindrical stick, which has the advantage of presenting no resistance to the passage of the fluid and generating only very little pressure drop, or even no pressure drop at all. It will preferably be positioned by means of one or two axial centering elements 14 in envelope 10, 10′, 10″. Centering element 14 is for example a metal grid with a known and regular porosity, for example 200 μm, provided with a central hole equal to the diameter of the polymer (cylinder) allowing positioning axially the polymer in the center of envelope 10, 10′, 10″ and at equal distances from its walls. This technique allows a homogeneous exchange of the gaseous or liquid phase with the polymer during the adsorption phase. Any other centering means may also be suitable, the main thing being that it does not hinder the circulation of the fluid and the interaction with the polymer, and that the contact surface with the polymer is as small as possible or even punctual.

Cartridge 1 can also contain a polymer in the form of a powder or glass balls coated with a polymer, an adsorbent of the activated carbon or graphite type, a porous polymer of the Tenax™ type, a diatomite or a clay, any microporous adsorbent carrier, but also miniaturized sensors, paper carriers impregnated with a reagent or colorimetric indicators, agars. Cartridge 1 can also contain an association of several capillary sections containing phases or adsorbents and arranged axially through centering element 14. The air will circulate through multi-selective capillaries and the pollutants will be trapped in this specific device.

Cartridge 1 can also contain a gelose for microbiological analyses. Legionella dosage may possibly be considered.

It is also possible to mount serially several cartridges containing the same trap or traps of different natures to increase selectivity when sampling unknown substances.

The dimensioning of cartridge 1 and of adsorbent material 13 with respect to each other is optimized to reduce the internal volume of cartridge 1, eliminate dead volumes, have only little or no inertia at all, and thus increase the sensitivity of cartridge 1.

Cartridge 1 is preferably advantageously conditioned under inert gas, for example argon, which is heavier than air, in order to prevent any cross-contamination with the exterior environment. Conditioning cartridge 1 under inert gas allows filling its internal volume with inert gas, pressurizing seals 110, 120 that close its ends. This overpressurization forms an indicator that allows checking the presence of a pressure in cartridge 1 and thus checking the tightness of cartridge 1 before using it.

The sealing of cartridge 1 is consequently carried out in the factory, under inert gas, by specific machines allowing controlling the force applied during the crimping operation for the concerned caps. One uses caps 11, 12 with a specific seal 110, 120 made of a silicone/aluminum or aluminum/silicone/aluminum membrane or of any other combination of equivalent materials, which withstands the high temperatures required for the thermal desorption technique, namely between 250° C. and 350° C. The neutrality of aluminum with regards to the traces to be analyzed is advantageous, and the barrier effect of aluminum allows achieving a perfect tightness against the most volatile molecules. Aluminum can be replaced with Teflon™, which has substantially the same properties. These seals 110, 120 can be made of a composite membrane, of a superposition of material layers, etc. Each cap 11, 12 comprises an external section out of metal with a hole 111, 121 closed by seal 110, 120. Seal 110, 120 can be pierced by a cannula. This seal 110, 120, which comprises silicone, has the advantage of being tightly resealable after removal of the cannula, therefore always ensuring the tightness of cartridge 1 after sampling.

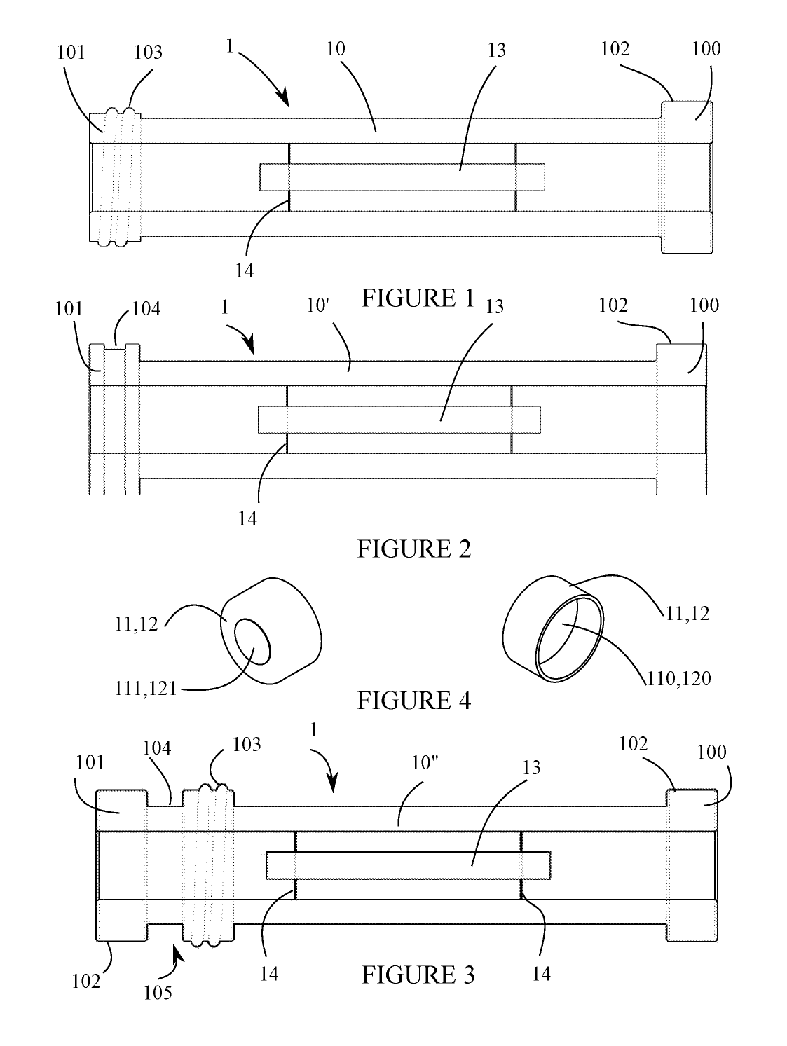

Envelope 10 of cartridge 1 illustrated in FIG. 1 is mixed: on side 100 it comprises a crimp-on end piece 102 and on the other side 101 a screw-on end piece 103.

Envelope 10′ of cartridge 1 illustrated in FIG. 2 is of the mixed type: on side 100 it comprises a crimp-on end piece 102 with a diameter that can be for example 11 mm, and on the other side a clip-on end piece 104 provided with an 11 mm double ring 101 allowing the use of clip-on caps 11, 12, but also of crimp-on caps.

Envelope 10″ of cartridge 1 illustrated in FIG. 3 is also of the mixed type allowing all combinations of caps 11, 12: on side 100 it comprises a crimp-on end piece 102, on the other side 101 a universal end piece 105 combining a crimp-on end piece 102 a screw-on end piece 103 and, between both, a clip-on end piece 104 allowing the use of clip-on, screw-on or crimp-on caps 11, 12. Envelope 10″ can replace the two other envelopes 10, 10′.

The various end pieces 102, 103, 104, 105 described are an integral part of glass envelope 10, 10′, 10″ since they are made during its manufacture, allowing ensuring the resistance and integrity of the envelope and consequently of cartridge 1.

These various end piece configurations thus allow opening cartridge 1 without using specific tools to remove adsorbing material 13 if necessary.

Cartridge 1 can comprise an envelope 10, 10′, 10″ whose walls are out of glass coated with a film (deposit of a selective phase of the silicone or PDMS type) with a suitable selectivity and film thickness. After the phase deposit, cartridge 1 is sealed under inert gas in the factory, as stated previously. This envelope 10, 10′, 10″ can be re-used several times.

Another, longer envelope variant can contain on-the-shelf sampling tubes used for thermal desorption.

The identification, follow-up and traceability of cartridge 1 will be possible, as it can be marked either by engraving (not represented) a QR code or a bar code with a laser, or by means of a label withstanding temperatures above 400° C., or by other identification means, for the follow-up of the production batch and its use during implementation. Cartridge 1 can contain a transponder (not represented) for easy identification during its whole duty cycle, that is to say from the sampling to the storage, up to the analysis.

Calibration and standardization of ready-to-use cartridge 1 is possible. A kit of calibrated sampling cartridges can be offered in order to allow a quantification of the sampled pollutants. The polymers will be isotopically labeled in order to avoid possible cross-contamination errors. The series of 50 ng, 100, 200, 500, 1000 ng standards will also include a blank and a tube containing quartz wool.

Calibration by the user is also possible. The fact of supplying the sampling system in the form of cartridges 1 sealed on both sides by a seal out of silicone/aluminum or aluminum/silicone/aluminum or out of any other equivalent combination allows the user to inject his own standard in cartridge 1 through seal 111, 121 using a suitable syringe.

As stated previously, cartridge 1 containing the solid polymer is not subject to pressure drops and therefore to flow variations due to the clogging of the classical polymers or adsorbents in powder form under the influence of the degree of humidity present during sampling, hence sampling regularity and accuracy.

Adsorbent material 13 can also be grafted or soaked with a derivating agent of the DNPH type for formaldehyde analysis.

The use of amber glass avoids the degradation of photosensitive molecules. The superficial treatment of the glass (passivation or deactivation) also allows lowering the detection limits of certain molecules such as those of the pesticides.

The use of an adsorbent material such as ready-to-use solid polymers allows retaining a control sample prior to the analysis. It is possible to use several polymers and to retain one as a control sample or to cut a polymer in two equal parts prior to the analysis.

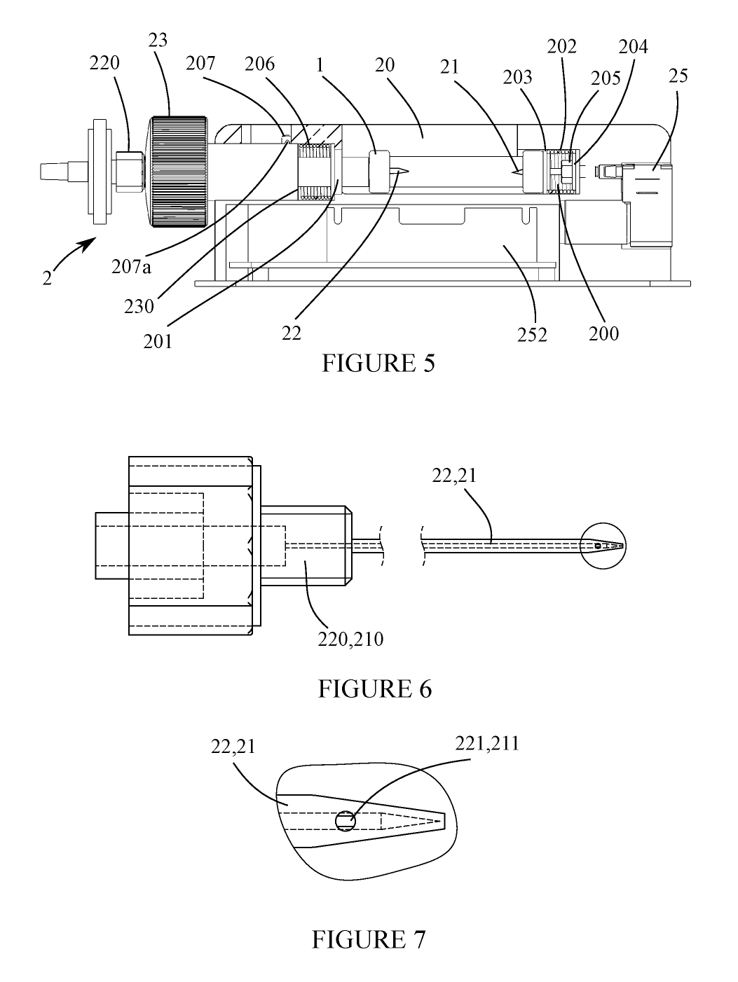

Sampling can be performed in active mode by means of a sampling device 2 according to the invention illustrated in FIGS. 5 to 8. Sampling device 2 comprises a housing 2′ wherein a space 20 is arranged for a ready-to-use sampling cartridge 1 according to the invention, this space 20 being accessible from the outside of housing 2′. It also comprises a fixed cannula 21 and a cannula 22 movable in translation arranged on either side of space 20, an actuating means 23 for moving movable cannula 22 between a retracted position and a cartridge 1 piercing position.

Each cannula 21, 22 represented in detail in FIGS. 6 and 7 is mounted on a ring 220, 210 of the Luer type and ends with a tapered tip with one side bore or several side bores 221, 211.

Fixed cannula 1 is placed at one of the ends 200 of space 20 with a nut 205. A compression spring 202 is arranged around fixed cannula 21, resting on end 200 on one side and on cartridge 1 on the other side. It is guided axially in a recess of housing 2′. Two washers 203 and 204 can be placed on either side of spring 202. Spring 202 will facilitate the extraction of cartridge 1 from sampling device 2. Fixed cannula 21 is connected to a suction pump 25.

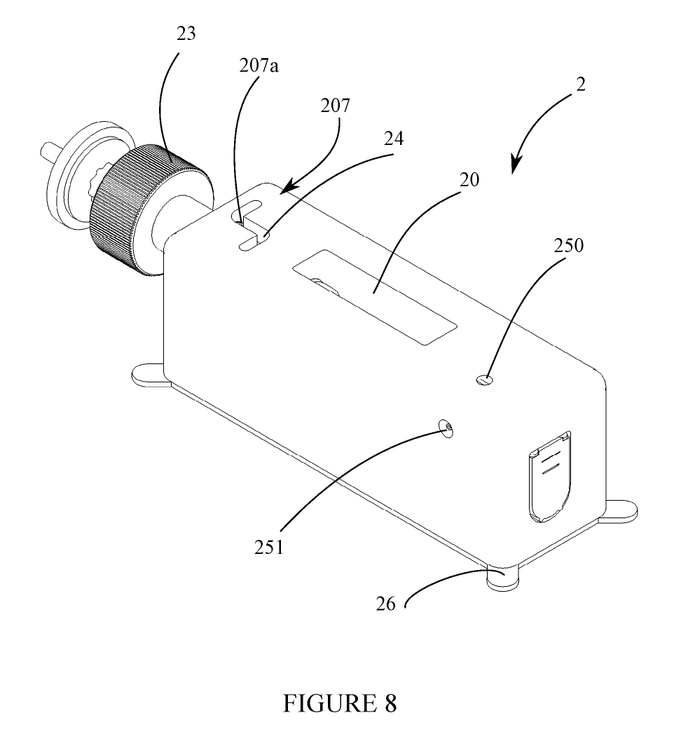

Movable cannula 22 is placed at the other end 201 of space 20; it is integral with actuating means 23, which includes a locking means 207 and a return spring 206. This actuating means 23 is made of a knurl in the represented example. Locking system 207 is made here of a pin 207a sliding in a track 24 provided in housing 2′ of sampling device 2 (see FIG. 8). Track 24 forms a S-shaped chicane that defines two stable positions of movable cannula 22: a retracted position wherein it stands back with respect to space 20 and allows introducing and removing cartridge 1, and a piercing position wherein it protrudes inside of space 20 and communicates with the internal volume of cartridge 1 after having pierced one of seals 110, 120. Any other equivalent actuating and locking means can be suitable. Return spring 206 is resting on end 201 on one side and on a shoulder 230 of actuating means 23 on the other side. It is guided axially in a recess of housing 2′.

Sampling device 2 also comprises a control 250 for adjusting the discharge of pump 25 and an outlet 251 for evacuating the air or the water or any other fluid to be analyzed. Pump 25 is powered by a battery 252 arranged in housing 2′ of sampling device 2. It can also include a charge level indicator for battery 252. If, during sampling, battery 252 reaches a too low charge level, which would not allow completing the planned sampling, the operator will be informed of the interruption of the sampling during the sample collection cycle, for example by means of a red LED. Sampling device system 2 can also comprise a preselection of fixed pre-programmed times, but it can also allow creating a more complex sampling cycle by means of an external software and a communication port on sampling device 2 to drive the operation of pump 25. It can finally comprise magnets 26 to allow fastening it on a metal surface or clips to hang it on the belt, or any other fastening means, according to the applications.

Sampling device 2 operates in active mode as follows: one places ready-to-use cartridge 1 in space 20, on pushes with actuating means 23 movable cannula 22 towards cartridge 1, which will move until it reaches fixed cannula 21, then compress spring 202, this will have the effect of piercing cartridge 1 at each of its two ends, one locks the piercing position of actuating means 23, and then one starts pump 25 to circulate the air or the water, or any other fluid to be analyzed, through cartridge 1, according to determined sampling parameters (flow and sampling time). After the active sampling step, one unlocks actuating means 23 to release cartridge 1 from fixed cannula 21 and movable cannula 22, which allows removing cartridge 1 to perform its analysis on site or in a laboratory. Thus, the use of cartridge 1 according to the invention is very practical, secure, without risk of operator or environmental contamination since the operator is never in contact with the analyzed fluid. Moreover, seals 110, 120 of cartridge 1 close up automatically in a tight manner after the removal of cannulas 21, 22, allowing storage in ambient air or cool storage, transport, handling of cartridge 1, without loss of information, even over several weeks, up until the analysis step.

This sampling device 2 can easily be automated. In this case, it is completed with a microprocessor and specific software, which control pump operation according to a program to perform sampling either in continuous mode or in sequential or pulsed mode. This sequential or pulsed mode allows trapping the fluid to be analyzed in cartridge 1 and letting it interact with adsorbent material 13 for a defined duration before expelling it and repeating the cycle. This operating mode is unique and very promising.

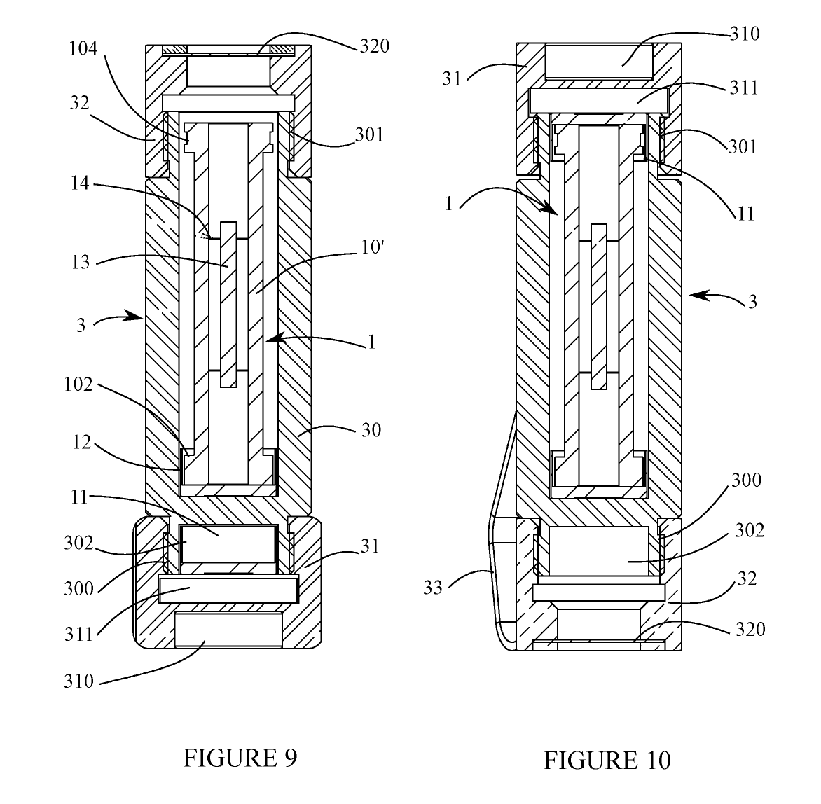

Sampling can also be performed in a passive way with sampling device 3 according to the invention illustrated in FIGS. 9 and 10. Sampling device 3 comprises a hollow body 30 that defines a space for receiving a ready-to-use cartridge 1 according to the invention, two threaded ends 300 and 301, a tight plug 31 and an open plug 32 equipped with a clipped-on diffusion grid 320. One of the ends 300 is closed while the other 301 is open. Closed end 300 comprises a recess 302. The two plugs 31 and 32 are interchangeable, that is to say that they can be placed equally on each of ends 300 and 301. Sampling device 3 is equipped with a clip 33 to allow hanging it on the belt or with any other fastening means. Tight plug 31 comprises a magnet 310 on the side opposite to the threaded side, and a seal 311 inside of the threaded section. Magnet 310 allows fastening sampling device 3 on a metal background or support.

To perform passive sampling, one unscrews open plug 32 of sampling device 3 provided with diffusion grid 320, one removes the clipped or screwed cap 11 of ready-to-use cartridge 1 to open envelope 10 and let the air enter, one arranges cartridge 1 in hollow body 30, one screws open plug 32 back in place on end 301, one unscrews tight plug 31 to place cap 11 of cartridge 1 in recess 302 of body 30, and one screws tight plug 31 back in place on end 300 (FIG. 9). One can carry sampling device 3 with the help of the clip, or fasten it magnetically on a metal support, or put or hang it in the room to be analyzed. Once sampling is completed after a duration determined between 8 hours and 4.5 days, one unscrews plugs 31 and 32, one puts cap 11 back in place on cartridge 1, which remains inside of body 30, one inverts plugs 31 and 32, and one screws tight plug 31 on open end 301 and open plug 32 on end 300. This ensures a double protection of cartridge 1 against external elements thanks to its cap 11 topped by tight plug 31, and it can be transported without any risk in sampling device 3 to the analysis place.

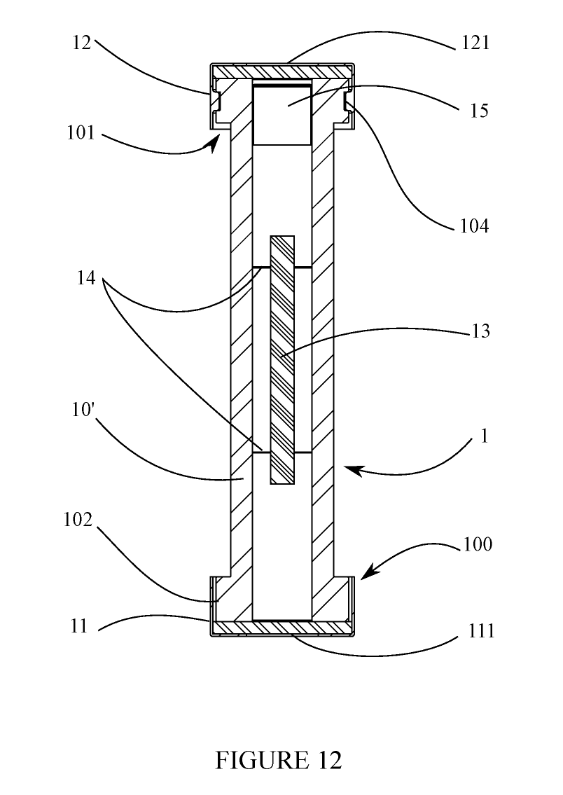

Passive sampling can also be performed with a ready-to-use cartridge 1 according to the invention as that of FIG. 12. In this cartridge 1, one inserted a diffusion grid 15 at one of the ends 101 of envelope 10′ of cartridge 1 of FIG. 2 for example. Cartridge 1 can comprise a fastening clip (not represented) to allow carrying it on the waist or hanging it on a support, or any other suitable fastening means. To perform sampling passively one removes cap 12 clipped on end piece 104 to open envelope 10′ and let the air enter. Once sampling is completed after a duration determined between 8 hours and 4.5 days, one closes envelope 10′ with cap 12. Cartridge 1 is sealed again and can be stored and transported without any risk to the analysis place. On can also use envelope 10 or 10″ of cartridge 1 of FIG. 1 or 3 according to the type of cap 12.

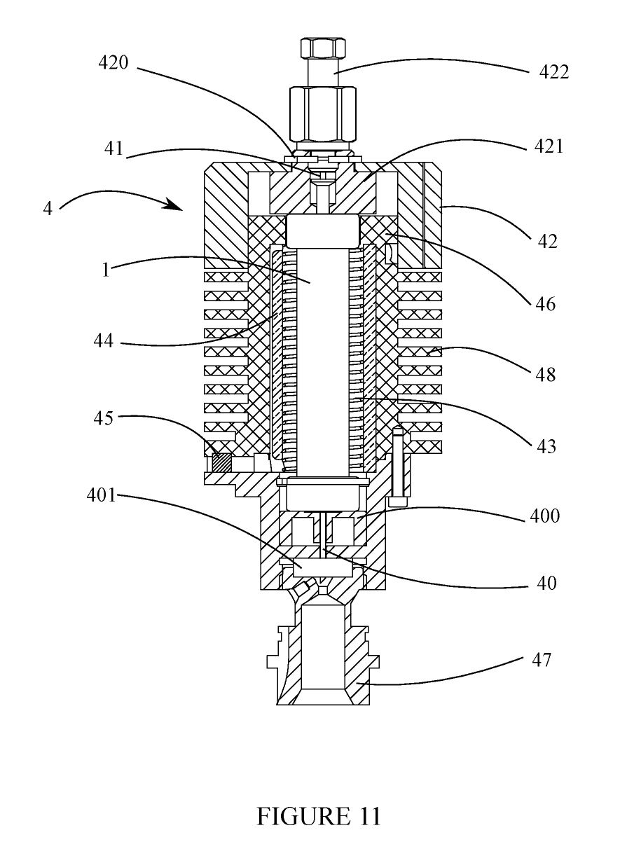

Once sampling is performed, the results must be extracted, and one can use for that purpose an extracting device 4 according to the invention as shown in FIG. 11. Extracting device 4 comprises a hollow body 46 that defines a space for receiving a cartridge 1 according to the invention used during an active or passive sampling. It moreover comprises a fixed cannula 40, a movable cannula 41 integral with a plug 42, a heating element 43 arranged in hollow body 46 to surround cartridge 1, an insulator 44 preferably out of ceramic arranged around heating element 43, and a connector 45 for the electrical power supply of heating element 43. Hollow body 46 comprises on its external wall fins 48 allowing heat dissipation. Fixed cannula 40 is placed in a needle holder 400 placed in hollow body 46 and connected to an injection end piece 47 through a septum 401 of an analyzer. Movable cannula 41 is connected to plug 42 by an elastic ring 420 and to a pusher 421 located inside of plug 42 that allows perforating seals 110, 120 at both ends of cartridge 1, for example by screwing plug 42 on hollow body 46. Plug 42 is equipped with an adapter 422 to allow connecting extracting device 4 to a carrier gas supply. The extraction of the sample collected by means of cartridge 1 is consequently made possible directly from cartridge 1 without having to open it, thus preserving the integrity of its content and avoiding any risk of cross-contamination. In addition, the quick heating of cartridge 1 due to its excellent heat conductivity allows transferring immediately and without having large dead volumes the desorbed compounds to the separative column and to the suitable detector of the chromatograph.

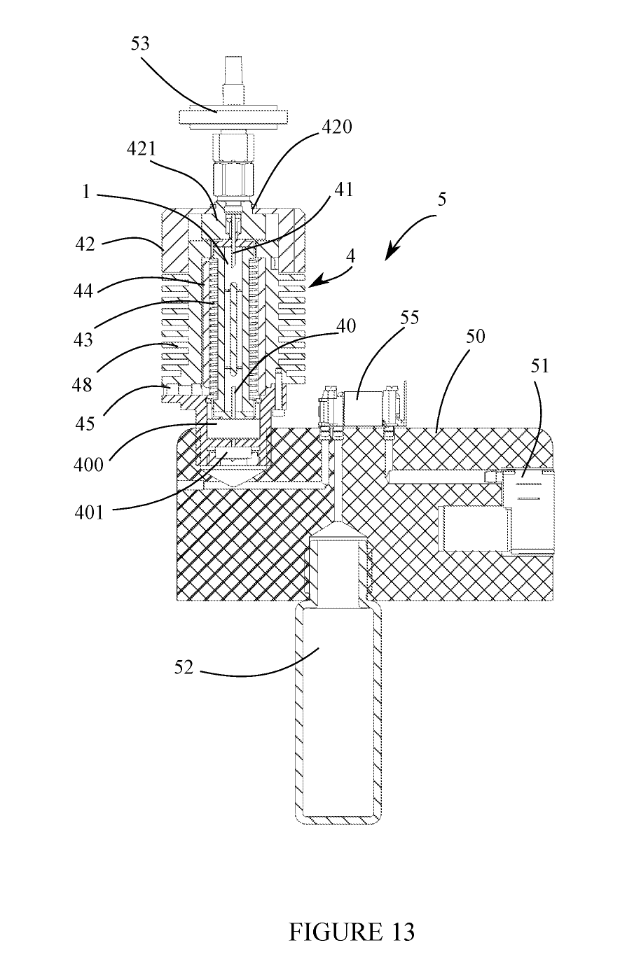

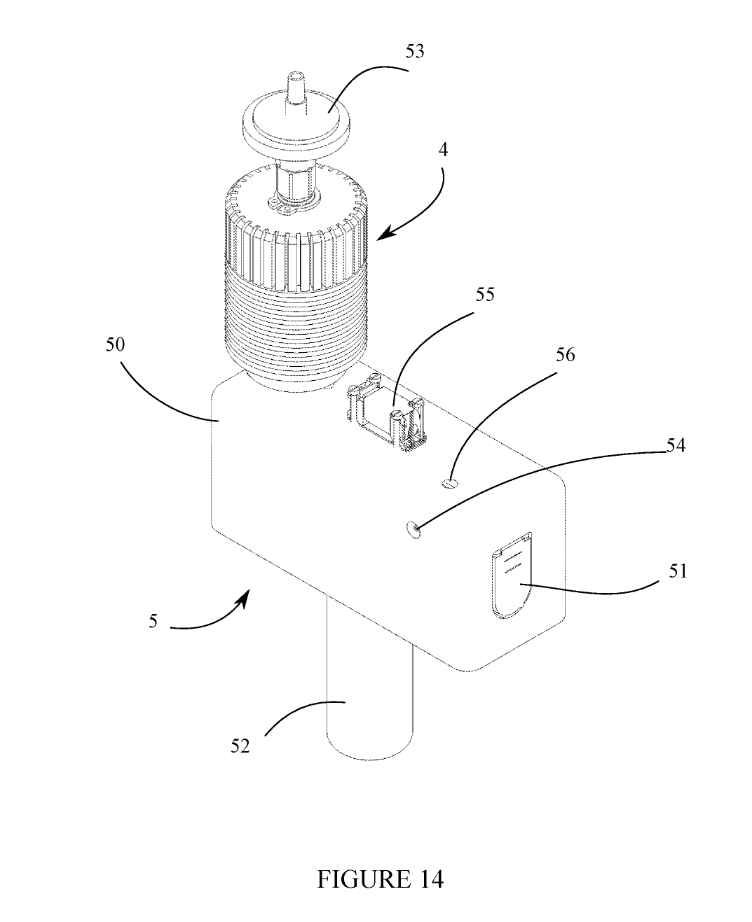

Sampling and extracting device 5 according to the invention illustrated in FIGS. 13 and 14 comprises an extracting device similar to that of FIG. 11 connected to a body 50 comprising a suction pump 51 and an inert gas tank 52. The inert gas can for example be helium. This sampling and extracting device 5 operates as follows in active mode: one places a ready-to-use cartridge 1 according to the invention in device 5, in the same way as for extracting device 4. A filter 53 is placed on extracting device 4 on the side opposite to body 50, suction pump 51 is started by a control 56 to suck in the external air through filter 53, cartridge 1 and body 50 via internal conduits. The air escapes through an opening 54 (FIG. 14). When sampling is completed, one stops pump 51, one removes filter 53 to replace it with a needle (not represented) with a Luer adapter intended to be connected to an analyzer (not represented). One opens inert gas tank 52 and, with solenoid valve 55, one puts tank 52 in communication with cartridge 1. This sampling and extracting device 5 has the advantage that it is portable and that it can be connected directly to a portable field analyzer that allows analyzing directly the compounds collected by cartridge 1.

### INDUSTRIAL APPLICATION

In all illustrated sampling modes, it appears clearly that the method according to the invention distinguishes itself from the known methods by the use of one single ready-to-use single-use sampling cartridge 1, which is entirely recyclable, preferably out of amber glass, sealed at both ends 100, 101 by high-performance pierceable seals 110, 120, and containing preferably a universal, single-use hydrophobic solid polymer with high adsorbent capacity, optimally arranged inside of cartridge 1, said cartridge being moreover conditioned under inert gas. Cartridge 1 is advantageously closed by two caps 11, 12 comprising each an opening 111, 121 closed by said seals 110, 120, which are pierceable, these caps 11, 12 can be sealed at both ends 100, 101, or at least one of caps 11, 12 can be removable with respect to one of ends 100, 101 to allow in particular performing sampling in passive mode. Cartridge 1 comprises for that purpose end pieces 102, 103, 104, 105 adapted at its both ends 100, 101, which are integrated in glass envelope 10, 10′, 10″. In addition, cartridge 1 can be identified thanks to a unique laser-engraved serial number and flash code, or by a label withstanding temperatures above 400° C.

After the sampling step, and without having to open cartridge 1, unlike the known sampling devices, it is now possible to desorb thermally, with low energy consumption and a low temperature gradient <60° C., all elements trapped on the polymer. The excellent inertia of cartridge 1, its low thermal mass and its perfect tightness allow obtaining a more reliable, more reproducible result, with better sensitivity than the classical devices, without any risk of cross-contamination.

Thus, cartridge 1 according to the invention, used both for sampling and thermal desorption, allows ensuring:
The quality of the data collected during sampling, this data being preserved and unalterable in the internal volume of cartridge 1, since the thermal desorption step does not require opening cartridge 1,
A constant and identical carrier gas flow during the sampling step and the thermal desorption step by carrier gas injection, furthering analysis accuracy,
Fast heating of cartridge 1 during thermal desorption, without adding any interface, simplifying and reducing analysis duration.

These various advantages, added to those set out previously, allow considering the realization of portable devices for analyzing the sampled pollutants directly on the sampling site, allowing significant time and costs saving and highly improved efficiency.

This description shows that the invention allows reaching the goals defined and overcoming all drawbacks of the known systems. It allows in particular offering a global solution ranging from the sampling to the analysis, totally controlled, secured and optimized, which no present solution allows reaching, as the different devices required for these different steps come from different manufacturers.

The present invention is not restricted to the examples of embodiment described, but extends to any modification and variant which is obvious to a person skilled in the art.

1-27. (canceled)

28. A method of sampling and extracting pollutants in a fluid, comprising using a single sampling cartridge (1) to perform, during a first step, sampling in a passive mode or in an active mode, and, during a second step, extracting collected pollutants by thermal desorption and circulating a carrier gas through the sampling cartridge (1),
carrying out the sampling step via the sampling cartridge (1) or of a sampling device (2, 3, 5) containing the sampling cartridge (1),
carrying out the extraction step via an extracting device (4) or a sampling and extracting device (5) containing the sampling cartridge (1),
conditioning the sampling cartridge (1) under an inert gas and comprising an envelope out of an inert material, containing an adsorbent material (13), sealed in a leaktight manner by two caps (11, 12) located at both ends (100, 101) of the envelope (10, 10′, 10″), and each cap (11, 12) having an opening (111, 121) closed by a pierceable seal (110, 120) made of a silicone film and at least one barrier layer.

29. The method of sampling and extracting according to claim 28, wherein, to perform the sampling step in the passive mode, removing one of the caps (11, 12) from the sampling cartridge (1) to open the envelope (10, 10′, 10″) and permitting the fluid to be analyzed enter and, once the sampling is obtained, again closing the envelope (10, 10′, 10″) with one of the caps (11, 12).

30. The method of sampling and extracting according to claim 28, wherein, to perform the sampling step in the active mode or the extraction step, leading the fluid to be analyzed or the carrier gas through the sampling cartridge (1) via cannulas of the sampling device (2), of the extracting device (4) or of the sampling and extracting device (5), to pierce through the seals (110, 120) of the sampling cartridge (1).

31. A sampling cartridge (1) for implementing the method according to claim 28, the sampling cartridge (1) comprising:
the envelope (10, 10′, 10″) made from the inert material, wherein the adsorbent material (13) is placed and sealed, in a leaktight manner by the two caps (11, 12) located at both ends (100, 101) of the envelope (10, 10′, 10″), each cap (11, 12) having an opening (111, 121) closed by the pierceable seal (110, 120) made of the silicone film and at least one barrier layer, and the sampling cartridge (1) containing the adsorbent material (13) is filled with the inert gas which is pressurized.

32. The sampling cartridge (1) according to claim 31, wherein the envelope (10, 10′, 10″) is cylindrical.

33. The sampling cartridge (1) according to claim 31, wherein the envelope (10, 10′, 10″) is made from glass.

34. The sampling cartridge (1) according to claim 33, wherein the envelope (10, 10′, 10″) is made from amber glass.

35. The sampling cartridge (1) according to 31, wherein the adsorbing material (13) is a polymer.

36. The sampling cartridge (1) according to claim 35, wherein the polymer has a shape of a solid stick positioned in a central section of the envelope (10, 10′, 10″) by at least one axial centering element (14).

37. The sampling cartridge (1) according to claim 28, wherein the at least one barrier layer is made from aluminum or Teflon™.

38. The sampling cartridge (1) according to claim 31, wherein the ends (100, 101) of the envelope (10, 10′, 10″) comprise crimp-on (102), screw-on (103), clip-on (104) and/or universal (105) end pieces to receive each a crimped, screwed and/or clipped cap (11, 12).

39. The sampling cartridge (1) according to claim 31, wherein the sampling cartridge (1) comprises an individual traceability marking.

40. The sampling cartridge (1) according to claim 33, wherein the sampling cartridge (1) comprises a heating resistor integrated in its glass envelope (10, 10′, 10″), and the caps (11, 12) are made from metal and form electrodes connected to the heating resistor.

41. An active sampling device (2) for implementing the method according to claim 28, comprising a space (20) for the sampling cartridge (1), wherein the sampling device (2) comprises a fixed cannula (21) and a movable cannula (22) in translation arranged on either side of the space (20), a means (23) for actuating the movable cannula (22) between a retracted position and a sampling cartridge (1) piercing position, and a system (207) for locking the movable cannula (22) in the piercing position, and the first and second cannulas (21, 22) being connected to a circuit for the fluid to be analyzed.

42. The sampling device (2) according to claim 41, wherein the actuating means (23) comprises a return spring (206) for returning the movable cannula (22) from the piercing position back to the retracted position.

43. The sampling device (2) according to claim 41, wherein the actuating means (23) comprises a locking means (207) in the form of a chicane.

44. The sampling device (2) according to claim 41, wherein the first cannula (22) is open towards external air and the second cannula (21) is connected to a suction pump (25).

45. The sampling device (2) according to claim 41, wherein first cannula (22) is connected to a water supply and the second cannula (21) to a gravity discharge outlet.

46. The sampling device (2) according to claim 45, wherein a solenoid valve is located upstream of the first cannula (22) connected to the water supply.

47. The sampling device (2) according to claim 41, wherein the first and the second cannulas (21, 22) end in a same water vial and a pump is located between one of the first and the second cannulas and the vial.

48. The sampling device (2) according to claim 41, wherein one of the first and the second cannulas comprises a mouthpiece.

49. A passive sampling device (3) for implementing the method according to claim 28, comprising a hollow body (30) defining a space for the sampling cartridge (1), wherein the hollow body (30) comprises a closed end (300) and an open end (301), and the passive sampling device (3) comprises two plugs (31, 32) mounted, in a removable manner, on the ends (300, 301) so as to be interchangeable, a tight first plug (31) and an open second plug (32) comprising a diffusion grid (320).

50. The passive sampling device (3) according to claim 49, wherein the closed end (300) comprises a recess (302) closed by one of the first and the second plugs (31, 32) to receive one of the caps (11, 12) of the sampling cartridge (1) during the sampling step.

51. The passive sampling device (3) according to claim 49, wherein the first plug (31) comprises a magnet (310) to fasten the device onto a metallic support.

52. The passive sampling device for implementing the method according to claim 28, comprising the sampling cartridge (1), wherein the sole sampling cartridge (1) forms the passive sampling device and the passive sampling device is equipped with a diffusion grid (15) arranged close to an end (100, 101) of the envelope (10, 10′, 10″) and with a tight cap (11, 12) clipped or screwed on the end.

53. An extracting device (4) for implementing the method according to claim 28, arranged between a carrier gas inlet and an analyzer, comprising a hollow body (46) that defines a space for the sampling cartridge (1) and a heating element (43) of the sampling cartridge (1), wherein the extracting device (4) comprises a fixed cannula (40) and a movable cannula (41) which is movable in translation arranged on each side of the housing, a pusher (421) coupled with the movable cannula (41) to move the movable cannula (41) between a retracted position and a sampling cartridge (1) piercing position, and one of the first and second cannulas (41) is intended for being connected to a carrier gas inlet and the other of the first and second cannulas (40) is connected to an injector of an analyzer.

54. A sampling and extracting device (5) for implementing the method according to claim 28, wherein the sampling and extracting device (5) comprises an extracting device (4) connected to a body (50) comprising a suction pump (51) and an inert gas tank (52), one of the first and the second cannulas (40) being connected through a solenoid valve (55) to the suction pump (51), during the sampling step, or to the inert gas tank (52), during the extraction step, and the other cannula (41) being intended to be connected to an air inlet, during the sampling step, or to an analyzer, during the extraction step.
